(19) United States
(12) Patent Application Publication
(10) Pub. No.: US 2026/0237810 A1
(43) Pub. Date: Aug. 13, 2026

(54) STACKED CURVED SOLID-STATE BATTERY CELLS AND BATTERIES, AND METHODS OF MAKING AND USING THE SAME

(71) Applicant: Ensurge Micropower ASA, Oslo (NO)

(72) Inventors: Richard VAN DER LINDE, San Jose, CA (US); Arvind KAMATH, Los Altos, CA (US)

(73) Assignee: Ensurge Micropower ASA, Oslo (NO)

(21) Appl. No.: 19/450,773

(22) Filed: Jan. 16, 2026

Related U.S. Application Data
(60) Provisional application No. 63/756,292, filed on Feb. 10, 2025.

(51) Int. Cl. H01M 50/213; H01M 4/66; H01M 10/058; H01M 50/107; H01M 50/244; H01M 50/526; H01M 50/548

(52) U.S. Cl. CPC H01M 50/213; H01M 4/661; H01M 10/058; H01M 50/107; H01M 50/244; H01M 50/526; H01M 50/548

(57) ABSTRACT

A curved solid-state battery and a method of making the same are disclosed. The battery includes a plurality of curved, stacked solid-state battery cells and first and second terminals on opposite sides or ends of the battery. Each battery cell comprises a cathode current collector (CCC), a cathode on the CCC, a solid-state electrolyte on the cathode, and an anode current collector (ACC) on the electrolyte. The method includes making a plurality of solid-state battery cells on a conductive metal or metal alloy substrate, stacking pairs of the battery cells face-to-face using an adhesive to create a plurality of cell pairs, stacking at least some of the cell pairs, compressing the stacked cell pairs in a shaping device to form curved stacked cell pairs, and terminating first and second edges of the curved stacked cell pairs with a flexible conductive adhesive.

### CROSS-REFERENCE TO RELATED APPLICATIONS

This application claims the benefit of U.S. Provisional Pat. Appl. No. 63/756,292, filed Feb. 10, 2025, pending, incorporated herein by reference in its entirety.

### FIELD OF THE INVENTION

The present invention generally relates to the field of solid-state and/or thin film batteries. More specifically, embodiments of the present invention pertain to stacked, curved solid-state battery cells and batteries, and methods of making and using the same.

### DISCUSSION OF THE BACKGROUND

Solid-state lithium batteries are ionic-charge storage devices that are ideally suited for wearable, IoT, and other non-EV applications due to their small size, safety, and high cyclability. Currently, they typically exist as single-cell devices, and require extrinsic packaging with relatively high area/volume overhead. These constraints limit the total charge capacity and volumetric energy density achievable.

An additional disadvantage of the single-cell approach is that it generally needs to be relatively large in the x-y dimensions in order to carry sufficient charge capacity. This potentially large footprint can limit usage in area-constrained applications. This disadvantage can be overcome by stacking and electrically joining cells, but constraints in the stacking and packaging processes and equipment generally limit the shapes of solid-state batteries containing stacked cells to flat, regular shapes (e.g., substantially rectangular or cuboid)

To support a broader range of products and applications, a solution is desired that enables a curved solid-state battery to have a relatively high charge capacity and volumetric energy density.

This “Discussion of the Background” section is provided for background information only. The statements in this “Discussion of the Background” are not an admission that the subject matter disclosed in this “Discussion of the Background” section constitutes prior art to the present disclosure, and no part of this “Discussion of the Background” section may be used as an admission that any part of this application, including this “Discussion of the Background” section, constitutes prior art to the present disclosure.

### SUMMARY OF THE INVENTION

Conventional curved solid-state lithium ion battery cells are rigid, and have a set radius, requiring a different battery size for each different curve or ring size. A flexible battery provides manufacturers a relatively streamlined bill of materials (BOM) with less need for variations or skews.

The present invention relates to solid-state and thin film batteries, and more specifically to a curved solid-state battery and methods of making and using the same. The present curved solid-state battery includes a plurality of curved, stacked solid-state battery cells and first and second terminals on opposite sides or ends of the battery and/or battery cells. Each of the cells generally comprises a cathode current collector (CCC), a cathode on the cathode current collector, a solid-state electrolyte on the cathode, and an anode current collector (ACC) on the electrolyte. The cells may further include a barrier and/or insulation film on the ACC with a via or opening therein exposing the ACC, and a conductive redistribution layer in the via or opening and on the barrier and/or insulation film. The barrier and/or insulation film and the redistribution layer may also be on a first sidewall of the cell, in that sequence.

The curved solid-state battery may further comprise a flexible conductive adhesive on each of the first and second terminals, a first electrically conductive tab or trace affixed or secured to one of the first and second terminals, and a second electrically conductive tab or trace affixed or secured to the other of the first and second terminals. One of the first and second tabs or traces may be electrically connected to each ACC through the terminal in electrical contact with the ACC (e.g., the redistribution layer on the first sidewall), and the other of the first and second tabs or traces may be electrically connected to each cathode or CCC on the second, opposite side or end of the battery through the other terminal in electrical contact therewith.

The curved, stacked solid-state battery cells may have a shape of an arc, a parabola, a piriform curve, a partial ellipse, or a combination thereof (e.g., a bell curve, a cycloid, etc.), and may have one or more linear or substantially linear sections.

In the present curved solid-state battery, the stacked solid-state battery cells may comprise a plurality of face-to-face pairs of solid-state battery cells with an adhesive between the faces of adjacent one of the solid-state battery cells in each such pair. Adjacent pairs of the solid-state battery cells may directly contact each other (e.g., in a back-to-back configuration). Alternatively, the stacked solid-state battery cells may comprise a plurality of face-to-back pairs of the solid-state battery cells with an adhesive between adjacent cells of each pair, and either a compressible layer or an additional adhesive layer between adjacent pairs of the cells.

This application also describes methods of stacking solid-state cells to allow for creating a curved battery. The method comprises making a plurality of solid-state battery cells on a substrate (e.g., comprising a conductive metal or metal alloy, such as stainless steel), stacking pairs of the plurality of solid-state battery cells using an adhesive (e.g., an anisotropic conductive film [ACF] or other conductive or non-conductive adhesive) to create a plurality of cell pairs, stacking at least some of the plurality of cell pairs, compressing the stacked cell pairs in a shaping device to form curved stacked cell pairs, and terminating first and second edges of the curved stacked cell pairs with a conductive adhesive (e.g., a flexible conductive adhesive). Each of the solid-state battery cells has an insulating coating on a first major surface and a conductor on a second, opposite major surface. The conductor is configured to form a first contact at the first edge of the solid-state battery cell, and the conductive substrate has an exposed surface providing a second contact on the second, opposite edge of the solid-state battery cell.

In some embodiments, the conductor comprises a redistribution layer (e.g., on the anode side of the solid-state battery cells) to electrically connect the anode current collector (ACC) to the first edge of the cell, forming an ACC contact. The exposed surface of the conductive substrate provides a cathode contact on the opposite side of the cell from the ACC contact.

Cell pairs adhered face-to-face may be stacked back-to-back without adhesive (e.g., so that the back surfaces of adjacent cells in adjacent pairs directly contact each other), and cell pairs adhered face-to-back (or back-to-face) are generally stacked with an adhesive. When the pairs of solid-state battery cells are stacked face-to-face, the adhesive may comprise an anisotropic conductive film (ACF), and the cell pairs may be stacked without additional adhesive between adjacent cell pairs. When the pairs of solid-state battery cells are stacked face-to-back, the cell pairs are stacked with either a compressible layer or an additional adhesive between adjacent cell pairs.

In some embodiments, the stacked cell pairs may be strapped or banded to hold them together. The strapped/banded cell pair stacks may then be placed in the shaping device to form a predetermined or desired curved shape.

In some embodiments, the method may further comprise fixing or securing an electrically conductive tab to each of the terminated first and second edges of the curved stacked cell pairs. The curved or shaped cell pair stacks may also be individually encapsulated in a flexible, protective packaging (such as mylar). When the curved or shaped stacked cell pairs have the tabs affixed or secured thereto, the tabs may be exposed through the packaging or encapsulant for connecting the battery (e.g., to a circuit or circuit board).

The present invention also relates to a shaping device, comprising a base having an opening or cavity exposing a curved inner surface, the curved inner surface having a plurality of parallel grooves or slots therein, each of the grooves or slots being configured to accommodate a stack of solid-state battery cells therein, and a shaping tool configured to impart a curved shape to the stack of solid-state battery cells in each of the grooves or slots, comprising an incompressible or substantially incompressible material, and having (i) a length substantially equal to a length of the inner surface of the base and (ii) a curved outer surface complementary or substantially complementary to the inner surface of the base.

In various embodiments of the present shaping device, each of the grooves or slots may have a width at least equal to and not more than 20% greater than a width of the stack of solid-state battery cells and an arc length greater than a length of the stack of solid-state battery cells, the opening or cavity in the base may have a width equal to or less than the length of the stack of solid-state battery cells, the base may be thermally conductive or include a thermally conductive material on the inner surface, and/or the base may further include a heating element configured to heat (i) ends of the stacks of solid-state battery cells to a temperature sufficient to cure a conductive adhesive thereon and/or (ii) the stacks of solid-state battery cells to a temperature facilitating the stacks of solid-state battery cells retaining the curved shape after removal from the shaping device.

The use of an ACF and the optional lack of adhesive between stacked pairs allows the curved battery to molded into any of a nearly limitless number of different curve sizes and/or shapes. The curved solid-state battery also has the following benefits: higher volumetric energy density (e.g., than curved single-cell solid-state batteries), faster charging, higher pulse discharge, and longer cycle life.

The present packaged solid-state battery has a relatively high active battery area utilization and low packaging overhead, thereby maximizing battery energy density. Other capabilities and advantages of the present invention will become readily apparent from the detailed description of various embodiments below.

### BRIEF DESCRIPTION OF THE DRAWINGS

FIG. 1 is a cross-sectional view of an exemplary solid-state battery cell, according to embodiments of the present invention.

FIG. 2 is a cross-sectional view of the exemplary solid-state battery cell of FIG. 1 with an anisotropic conductive film thereon, according to embodiments of the present invention.

FIGS. 3A-B are cross-sectional views of exemplary stacked pairs of solid-state battery cells, according to embodiments of the present invention.

FIGS. 4A-B are cross-sectional views of exemplary multi-pair stacks of solid-state battery cells, according to embodiments of the present invention.

FIG. 5 is a perspective view of an exemplary banded multi-pair stack of solid-state battery cells, according to embodiments of the present invention.

FIG. 6 is a perspective view of an exemplary base of an exemplary shaping device, according to one or more embodiments of the present invention.

FIG. 7 is a perspective view of the exemplary base of FIG. 6, with multiple banded multi-pair stacks of solid-state battery cells thereon, according to one or more embodiments of the present invention.

FIG. 8 is a perspective view of the exemplary base and banded multi-pair stacks of solid-state battery cells of FIG. 7, with a curved shaping tool in position to shape the solid-state battery cell stacks, according to one or more embodiments of the present invention.

FIG. 9 is a side or end view of the exemplary shaping device of FIG. 8 compressing the solid-state battery stacks according to one or more embodiments of the present invention.

FIG. 10 is a side or end view of the exemplary shaping device of FIG. 8 with a conductive adhesive applied to ends of the solid-state battery stacks, according to one or more embodiments of the present invention.

FIG. 11 is a side or end view of the exemplary shaping device of FIG. 8 with a conductive tab affixed to ends of the solid-state battery stacks, according to one or more embodiments of the present invention.

FIG. 12 is a side view of an exemplary curved multi-cell solid-state battery, according to one or more embodiments of the present invention.

### DETAILED DESCRIPTION

Reference will now be made in detail to various embodiments of the invention, examples of which are illustrated in the accompanying drawings. While the invention will be described in conjunction with the following embodiments, it will be understood that the descriptions are not intended to limit the invention to these embodiments. On the contrary, the invention is intended to cover alternatives, modifications and equivalents that may be included within the spirit and scope of the invention. Furthermore, in the following detailed description, numerous specific details are set forth in order to provide a thorough understanding of the present invention. However, it will be readily apparent to one skilled in the art that the present invention may be practiced without these specific details. In other instances, well-known methods, procedures and components have not been described in detail so as not to unnecessarily obscure aspects of the present invention. Furthermore, it should be understood that the possible permutations and combinations described herein are not meant to limit the invention. Specifically, variations that are not inconsistent may be mixed and matched as desired.

The technical proposal(s) of embodiments of the present invention will be fully and clearly described in conjunction with the drawings in the following embodiments. It will be understood that the descriptions are not intended to limit the invention to these embodiments. Based on the described embodiments of the present invention, other embodiments can be obtained by one skilled in the art without creative contribution and are in the scope of legal protection given to the present invention.

Furthermore, all characteristics, measures or processes disclosed in this document, except characteristics and/or processes that are mutually exclusive, can be combined in any manner and in any combination possible. Any characteristic disclosed in the present specification, claims, Abstract and Figures can be replaced by other equivalent characteristics or characteristics with similar objectives, purposes and/or functions, unless specified otherwise.

For the sake of convenience and simplicity, the term “length” generally refers to the largest dimension of a given 3-dimensional structure or feature. The term “width” generally refers to the second largest dimension of a given 3-dimensional structure or feature. The term “thickness” generally refers to a smallest dimension of a given 3-dimensional structure or feature. The length and the width, or the width and the thickness, may be the same in some cases. A “major surface” refers to a surface defined by the two largest dimensions of a given structure or feature, which in the case of a structure or feature having a circular surface, may be defined by the radius of the circle.

In addition, for convenience and simplicity, the terms “part,” “portion,” and “region” may be used interchangeably but these terms are also generally given their art-recognized meanings. Also, unless indicated otherwise from the context of its use herein, the terms “known,” “fixed,” “given,” “certain” and “predetermined” generally refer to a value, quantity, parameter, constraint, condition, state, process, procedure, method, practice, or combination thereof that is, in theory, variable, but is typically set in advance and not varied thereafter when in use.

The present invention concerns a curved solid-state battery cell, a curved stack of solid-state battery cells, and methods of making the same. The present solid-state battery cell is an intrinsic anode-less battery, including a substrate, a cathode on the substrate, a solid-state electrolyte (SSE) on the cathode, and an anode current collector (ACC) on the SSE. The substrate, which generally comprises a metal sheet or foil, may serve as the cathode current collector (CCC).

FIG. 1 shows an exemplary solid-state battery cell 100, including a substrate 110, a cathode 120 on the substrate 110, a solid-state electrolyte 130 on the cathode 120, an anode current collector (ACC) 140 on the electrolyte 130, a mechanically compliant moisture barrier and electrical insulation film 150, and a redistribution layer 160 on the insulation film 150 and a via 162 in an opening in the barrier/insulation film 150, thus forming substantially complete (but unpackaged) cells. Exemplary methods for making the solid-state battery cell 100 are disclosed in U.S. patent application Ser. Nos. 18/314,616, Ser. No. 18/319,532, Ser. No. 18/319,552, Ser. No. 18/640,416, Ser. No. 18/885,525, Ser. No. 18/925,892, Ser. No. 18/925,267 and Ser. No. 18/946,887 (Atty. Docket Nos. IDR2022-01 through-03 and IDR2022-06 through -10). In the present invention, the cells may advantageously have an aspect ratio (i.e., length-to-width ratio) of ≥2:1, ≥3:1, or greater.

In some embodiments, the battery cell 100 includes an anode-free ACC 140, which may be defined with minimal pull-back from the cell edges. This design also maximizes area utilization. Furthermore, the use of an underlying blanket cathode 120 and a blanket solid-state electrolyte 130 results in a flat or planar ACC 140, which minimizes mechanical stresses from Li plating and/or stripping during cell cycling. A separately-formed anode is not necessary in solid-state lithium batteries, as a lithium anode can be formed between the electrolyte 130 and the ACC 140 during charging, if necessary. Optionally, however, a thin lithium anode can be deposited by evaporation onto the electrolyte 130 prior to formation of the ACC 140.

The substrate 110 may comprise a metal foil, sheet or film and optional first and second barriers on opposite major surfaces of the metal foil, sheet or film. The metal foil may comprise or consist essentially of stainless steel, aluminum, copper, nickel, inconel, brass, molybdenum or titanium, the elemental metals of which may be alloyed with up to 10% of one or more other elements to improve one or more physical and/or chemical properties thereof (e.g., oxygen and/or water permeability, flexibility, resistance to corrosion or chemical attack during subsequent processing, etc.). However, the sheet or film can also be a metal sheet or metal roll. For example, the sheet or film may be 10-100 μm thick, whereas a metal sheet may have a thickness of >100 μm, up to about 1-2 mm, although the invention is not so limited. Other alternative substrates include a metal coating on a mechanical substrate, such as aluminum, copper, nickel, titanium, etc., on a removable plastic film, sheet or roll.

The first barrier may comprise one or more layers of one or more materials in a thickness effective to prevent migration of atoms or ions from the metal foil, sheet or film into overlying layers. The barrier material(s) may comprise a glass or ceramic, such as silicon dioxide, aluminum oxide, silicon nitride, a silicon and/or aluminum oxynitride, etc., or a (refractory) metal nitride, such as aluminum nitride, titanium nitride, titanium aluminum nitride, tungsten nitride, titanium tungsten nitride, TiW alloy, tantalum nitride, etc. In some embodiments, each of the first and second barriers comprises alternating glass/ceramic and metal nitride layers (e.g., a first metal nitride layer, a first glass/ceramic layer, and a second metal nitride layer, which may further comprise a second glass/ceramic layer, a third metal nitride layer, etc.). Each barrier may have a total thickness of 0.05-3 μm, but the barrier is not limited to this range. The barriers may be blanket-deposited onto the metal foil, sheet or film by chemical or physical vapor deposition (e.g., sputtering, thermal evaporation, atomic layer deposition [ALD], etc.), solution-phase coating with a precursor material followed by annealing to form the glass/ceramic or metal nitride, etc. Exemplary barrier materials, structures and thicknesses and methods for their deposition are disclosed in U.S. Pat. Nos. 9,299,845 and 11,742,363, the relevant portions of each of which are incorporated by reference herein.

In some embodiments, the metal foil, sheet or film in the substrate 110 functions as a cathode current collector (CCC). In such embodiments, at least the first (e.g., topside) barrier is a conductive, amorphous material, such as the refractory metal nitrides listed above or an amorphous metal alloy (e.g., a TiW alloy). In other or further embodiments, the substrate 110 comprises a thin stainless-steel (SS) foil (e.g., a sheet or roll), which also functions as the cathode current collector. In such embodiments, there is no need for a separate CCC layer, which consumes space in the battery cell and increases complexity of the method of making the battery. SS is mechanically strong, and therefore, its thickness can be minimized (e.g., to 3-50 μm) to maximize cell energy density.

The cathode 120 may comprise a lithium metal oxide or lithium metal phosphate, such as lithium cobalt oxide (LiCoO₂; LCO), lithium manganese oxide (LiMn₂O₄; LMO), or lithium iron phosphate (LiFePO₄; LFP), for example. The cathode 120 may be blanket deposited by laser deposition (e.g., pulsed laser deposition or PLD), sputtering, chemical vapor deposition (CVD), sol-gel processing, etc. Alternatively, the cathode 120 may be selectively deposited by screen printing, inkjet printing, spray coating, or extrusion coating (e.g., using an ink comprising one or more sol-gel precursors and one or more solvents, having a viscosity appropriate for the printing or coating technique).

In a further alternative, the cathode 120 may comprise a lithium metal oxide or lithium metal phosphate ceramic sheet. Such ceramic sheets may be on a backing material (e.g., a polymeric tape), and thus be transferable, and may have a width similar or identical to a sheet or roll of the substrate 110. Such lithium metal oxide and lithium metal phosphate ceramic sheets may have a thickness of 15-50 μm, or any value or range of values therein. and are commercially available from NEI Corporation (Somerset, NJ), Targray (Kirkland, Canada), and MSE Supplies (Tucson, AZ). The sheet may be adhered to the substrate 110 using a thin layer (e.g., 300 Å-2 μm) of an elemental metal, such as aluminum or titanium, or an electrically conductive alloy, such as a conventional tin solder.

The electrolyte 130 may comprise or consist essentially of a conventional lithium phosphorus oxynitride (LiPON), which may optionally be carbon-doped, or Li₂WO₄, a good Li-ion conductor. Alternatively, the electrolyte 130 may comprise or consist essentially of one or more layers of a lithium lanthanum zirconium oxide (LLZO). In some embodiments, the electrolyte 130 may further comprise optional cathode and/or anode interface layers (not shown), each of which may comprise a lithiated metal oxide (see, e.g., U.S. Pat. No. 11,735,791, the relevant portion(s) of which are incorporated herein by reference).

Forming the electrolyte 130 may comprise depositing a LiPON layer or a tungsten oxide layer of the formula WO₃₊ₓ (0≤x≤1) by sputtering, optionally using pulsed DC power. When the electrolyte 130 comprises LiPON, it may be deposited by RF sputtering or ALD. The sputtering target may comprise a Li₃PO₄ or mixed graphite-Li₃PO₄ target, the latter of which may contain 1-15 wt % of graphite, when the electrolyte 130 comprises LiPON or carbon-doped LiPON, and a metallic/elemental tungsten target when the electrolyte 130 comprises a tungsten oxide. In the latter case, sputtering is performed in an oxygen or oxygen-containing atmosphere. The method of making the electrolyte 130 may further comprise lithiating and thermally annealing the WO₃₊ₓ, which can transform it into Li₂WO₄, a good Li-ion conductor. Lithiating may comprise wet lithiation (e.g., immersing the WO₃₊ₓ in a solution containing a lithium electrolyte such as LiClO₄, LiPF₆, LiBF₄, etc., and applying an appropriate electric field) or dry lithiation (e.g., sputtering or thermally evaporating elemental lithium onto the tungsten oxide in a vacuum chamber, optionally while heating the substrate 100). Thermal annealing may comprise heating at a temperature of 150-500° C. for a length of time of 5-240 minutes, or any temperature or length of time therein (e.g., 250-450° C. for 10-120 minutes), in a conventional oven, a vacuum oven, or a furnace. To ensure substantially complete diffusion of the lithium into and/or throughout the WO₃₊ₓ, the WO₃₊ₓ should be annealed (preferably in air) at a temperature of at least 100° C. for at least 10 minutes (e.g., to transform it into Li₂WO₄).

An LLZO electrolyte 130 may be formed by depositing an LLZO sol-gel (e.g., by spic-coating, extrusion coating, dip-coating, drip-casting, etc.), then annealing at a temperature in the range of 500-800° C., or any value or range of values therein for 1-60 minutes in an oxygen-containing gas such as clean dry air (CDA). Examples of such a process can be found in U.S. Prov. Pat. Appl. No. 63/750,738, filed Jan. 28, 2025 (Atty. Docket No. IDR 2024-01-PR), the relevant portions of which are incorporated herein by reference.

The ACC 140 generally comprises a conductive metal, such as nickel, zinc, copper, an alloy thereof (e.g., NiV), etc., or another conductor, such as graphite. The ACC 140 can be selectively deposited by screen printing, inkjet printing, spray coating (e.g., through a mask), etc., or formed by blanket deposition (e.g., sputtering or evaporation) and patterning (e.g., low-resolution photolithography, development and etching). The ACC 140 may have a thickness of 0.1-5 μm, although it is not limited to this range.

The ACC 140 may have area dimensions (i.e., length and width dimensions) that are 50-95% of the corresponding length and width dimensions, respectively, of the cell, although the borders of the ACC 140 may be offset (pulled back) a minimal distance from the ultimate cell borders, in some embodiments. The pull-back distance of the ACC 140 from the cell edges should be sufficient to electrically isolate the ACC 140 from the CCC/substrate 110.

The cells may further include one or more interlayers that modify the interfaces between layers. For example, a metal oxide (e.g., Nb₂O₅, Al₂O₃, Li₄Ti₅O₁₂ or LiNbO₃) interlayer may be formed on the cathode 120 prior to deposition of the electrolyte 130 (e.g., to reduce interfacial stress, decrease interfacial resistance, or suppress formation of a space charge layer). An amorphous (e.g., elemental silicon) interlayer may be deposited on the electrolyte 130 prior to formation of the ACC 140 to inhibit reduction of the electrolyte. Of course, the battery cell can be made in the reverse order (i.e., the anode current collector may be first formed on the substrate, then the remaining layers deposited in reverse order thereon).

An advantage of the present method is that some/all of the active battery layers (e.g., the cathode 120 and the solid-state electrolyte 130) are deposited as blanket layers. This maximizes the active area utilization of the battery cells for high intrinsic capacity, and also results in a topographically planar or “flat” cell to facilitate formation of the uppermost layer(s) and downstream packaging due to the pattern-free blanket-deposited layers. However, if necessary or desired, the cathode 120 and the SSE 130 can be slightly pulled back from the cell edge by subtractive patterning (e.g., low-resolution photolithography, laser ablation) or selective deposition (as described herein).

The barrier/insulation film 150 may comprise parylene or other polymer having similar mechanical strength (e.g., a relatively high tensile strength compared to polyethylene and/or polypropylene), Al₂O₃ or SiO₂ (either of which may be deposited at a relatively low temperature), combinations thereof (e.g., a parylene/Al₂O₃ bilayer), or another suitable barrier/insulation film. Additionally, the barrier/insulation film 150 may be coated with a polycarbonate or a diamond-like (e.g., amorphous carbon) coating for additional mechanical protection. The barrier/insulation film 150 covers all front, back and side surfaces of the cell except for the side surface including the CCC contact surface 115, and may be formed by pyrolysis, thermal CVD, ALD, inkjet printing, or screen printing.

The redistribution layer 160 and via 162 generally comprise a conductive metal or metal alloy, and is deposited or otherwise formed along the “ACC edge” of the cell (on the sidewall of the barrier/insulation film 150) to connect the ACC 140 to a subsequently formed external battery terminal. The opening may be formed in the barrier/insulation film 150 by (i) laser ablation or (ii) masking and etching. Alternatively, the opening may be formed by patterned encapsulation/deposition of the material(s) for the barrier/insulation film 150 on the upper surface of the cells. The redistribution layer 160 may comprise Cu, Ni, Al, another suitable metal, or an alloy of Cu, Ni, Al, or the other metal, and may be formed by sputtering or thermal evaporation (e.g., through a mask that exposes a region of the cell corresponding to the pattern of the redistribution layer 160), followed by removal of the mask, or by selective deposition, such as inkjet printing or screen printing. The redistribution layer (or ACC trace) 160 goes from the ACC 140 exposed through the opening in the barrier/insulation film 150 to the ACC edge of the cell, opposite from the CCC edge or contact surface 115.

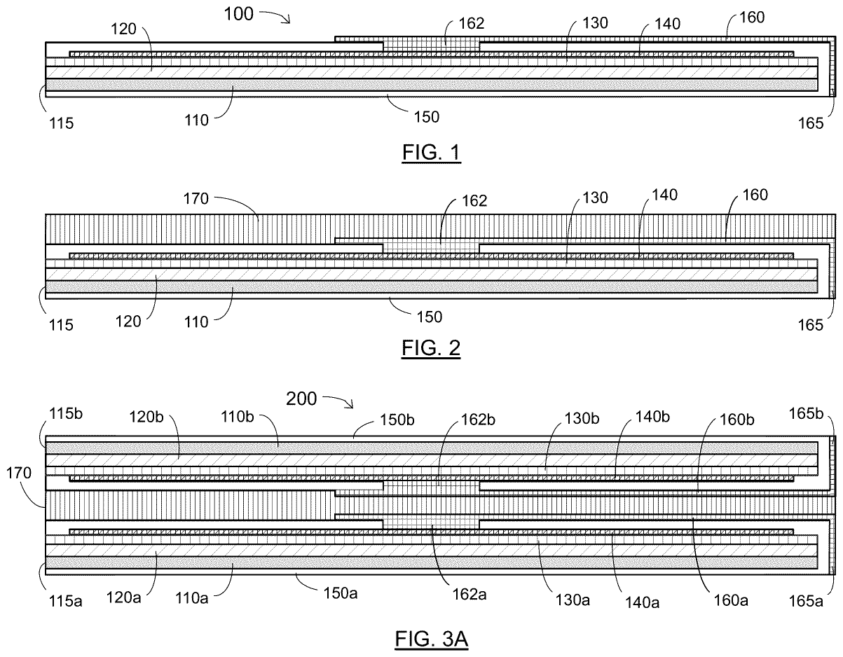

FIG. 2 shows the exemplary solid-state battery cell 100 with an anisotropic conductive film (ACF) 170 on the uppermost surfaces of the redistribution layer 160 and the barrier/insulation film 150. The ACF 170 is configured to bond electronic components at room temperature and optionally at low pressure (e.g., <5 bar), and may comprise a dispersion of conductive particles (e.g., Ag, Ni, Au) in a polymer matrix (e.g., a polyacrylate or other poly[meth]acrylate-based pressure sensitive adhesive, an epoxy resin, etc.). The conductive particles may be aligned (e.g., using an electric field) to create directional chains (e.g., E-Align ACFs from CondAlign, Oslo, Norway) for directional conductivity. In various embodiments, the ACF 170 has a thickness of 10-100 μm, or any thickness or range of thicknesses therein (e.g., 20 μm). The thinner the ACF 170, the greater the volumetric energy density (VED) of the stacked cells. In the ACF 170, current flows only or substantially only in a vertical direction (i.e., away from the redistribution layer 160). As a result, there is little concern with the ACF 170 inadvertently short-circuiting the redistribution layer 160 and the CCC contact surface 115.

Alternatively, the ACF 170 can be replaced with a solder or other conductive adhesive. However, in such cases, it may be advantageous to include an insulating border (e.g., using a polymer such as polyethylene terephthalate [PET], a silicone polymer, etc.) around the solder or conductive paste (e.g., to prevent shorting during a subsequent dipping process). The ACF 170 is relatively simple to apply and use, since the current only flows vertically in the ACF 170, and many ACFs are commercially available as thin films on a transfer tape.

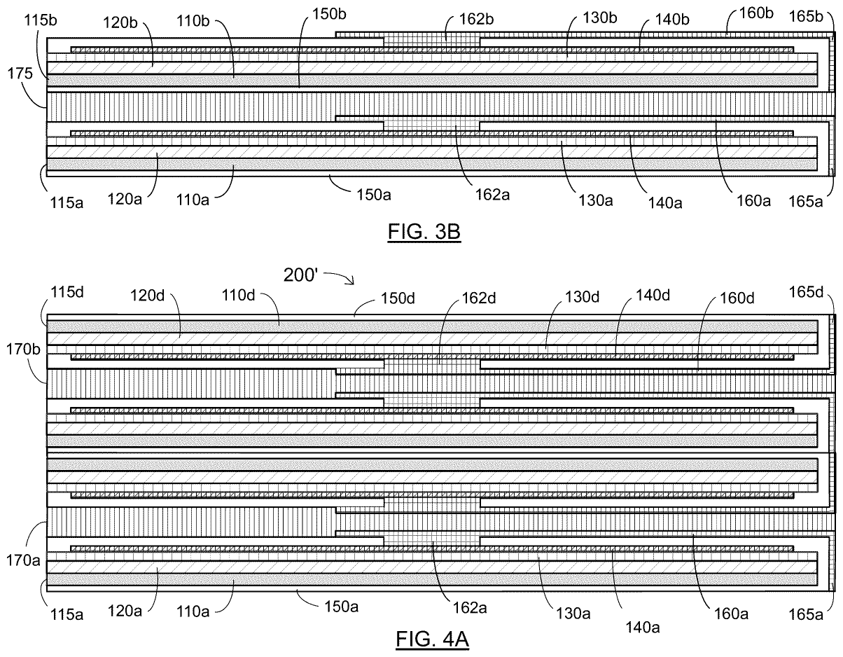

A second cell is bonded to the ACF 170 via its uppermost surface (i.e., the redistribution layer 160b and the barrier/insulation film 150b as shown in FIG. 3A) to form a cell pair 200, in a face-to-face configuration. At the point shown in FIG. 3A, the ACF 170 electrically connects the redistribution layers 160a and 160b of the two battery cells, effectively joining the ACC contact surfaces 165a and 165b on the sidewalls of the cells. The ACF 170 may also be somewhat compressible, to fill the variable gap between the upper faces of the cells and/or to allow formation of a lithium anode during charging without changing the volume of the packaged cells.

Alternatively, the ACF 170 in FIG. 2 can be replaced with a non-conductive adhesive 175 (FIG. 3B), and a second cell bonded to the adhesive 175 via its lowermost surface (i.e., the barrier/insulation film 150b-covered substrate 110) to form a cell pair in a face-to-back configuration, as shown in FIG. 3B. In the embodiment shown in FIG. 3B, the adhesive 175 may be conductive (e.g., an ACF), which when extended to the ACC edge of the cell, electrically connects the redistribution layer 160a of a first battery cell 160b with an ACC contact surface 165b on the sidewall of the adjacent battery cell, but typically not as effectively as the face-to-face configuration shown in FIG. 3A. In embodiments in which the adhesive 175 does not extend to the edge(s) of the cell, the adhesive 175 should not make any electrical connections, in which case a non-conductive adhesive may be preferred. The adhesive 175 may also be somewhat compressible, similar to the ACF 170 in FIG. 3A.

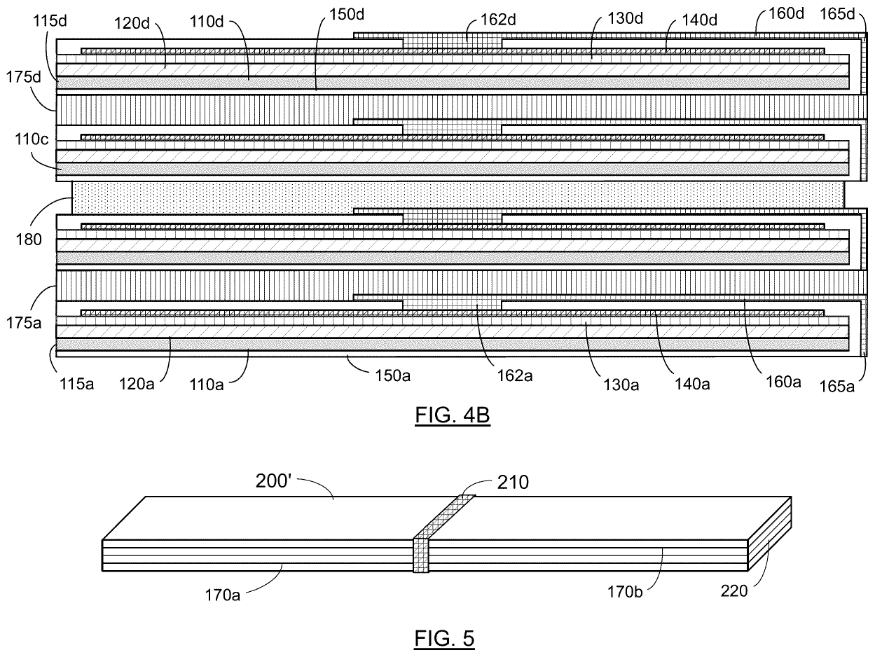

Multiple ACF-adhered cell pairs 200 may be stacked (e.g., back-to-back), as shown in FIG. 4A. Although only two pairs (four total cells) are shown in FIG. 4A, the stack 200′ may include any number of stacked cell pairs 200 (e.g., 3, 4, 5 or more pairs). Ultimately, the number of cell pairs in the stack 200′ is limited only by the design requirements (e.g., total thickness) of the packaged battery. The cell pairs 200 can be stacked using conventional pick-and-place equipment, placing the cell pairs into recesses in a tray or other holder having dimensions configured to substantially align the stack, while allowing some relatively minimal margins for placement of the cell pairs 200 in the recess.

Similarly, multiple face-to-back-adhered cell pairs (FIG. 3B) may be stacked, as shown in FIG. 4B. In such embodiments, to protect the exposed redistribution layer 160b in FIG. 3B and minimize the probability of short-circuits or other undesired electrical issues between the redistribution layer 160b and the overlying substrate 110c (FIG. 4B), an additional layer 180 may be placed on the exposed redistribution layer 160b and insulation layer 150b before stacking the second cell pair thereon. In some embodiments, the additional layer 180 may be or comprise a non-conductive adhesive. In other embodiments, the additional layer 180 may be or comprise a compressible layer, to fill the variable gap between the face and back of the adjacent cells and/or to allow formation of a lithium anode during charging without changing the volume of the packaged cells. In some cases, the additional layer 180 may be or comprise a compressible adhesive (e.g., silicone adhesives). Compressible layers that have a compressibility configured or adapted to maintain or substantially maintain a constant thickness or volume for a solid-state battery cell stack during charging and discharging of the solid-state battery cells therein are disclosed in U.S. Prov. Pat. Appl. No. 63/907,978, filed Oct. 30, 2025, the relevant portions of which are incorporated herein by reference.

In other possible embodiments, the ACF 170 or adhesive 175 can be applied to the back surface of the cell, which may be advantageous because to layer 170 or 175 is applied to a smooth surface, devoid of topography. In such cases, stacking may be back-to-back or back-to-face. Back-to-back stacking embodiments result in cell pair stacks that are similar to the stack 200′ shown in FIG. 4A, but with an additional adhesive layer between the back-facing surfaces of adjacent cell pairs 200. Back-to-face stacking embodiments result in cell pair stacks that are similar to the stack shown in FIG. 4B, but in which a third adhesive layer 175 replaces the additional layer 180.

FIG. 5 shows the exemplary cell pair stack 200′ with a band 210 around its center (along the length direction of the stack 200′). The band 210 may comprise a flexible, thin, relatively mechanically robust material such as a polyimide film (e.g., KAPTON®, available from DuPont de Nemours Inc., Wilmington, DE). Preferably, the material for the band 210 is able to tolerate any subsequent curing temperature. The band 210 may have a width of 0.1-5 mm (or any width or range of widths therein) and a thickness of 10-250 μm, although a smaller (e.g., thinner) band is better for the VED of the battery. In addition, the cell pair stack 200′ may have more than one band 210 around it (for example, depending on the aspect ratio of the cells 100). Typically, the cell pair stack 200′ includes no more than two bands 210 (e.g., at or near opposite ends of the stack 200′). In some embodiments, each of the cells 100 may include notches in locations along its periphery corresponding to the position of the band(s) 210 in the cell pair stack 200′. Such notches may have a depth equal to or slightly greater than the thickness of the band(s) 210.

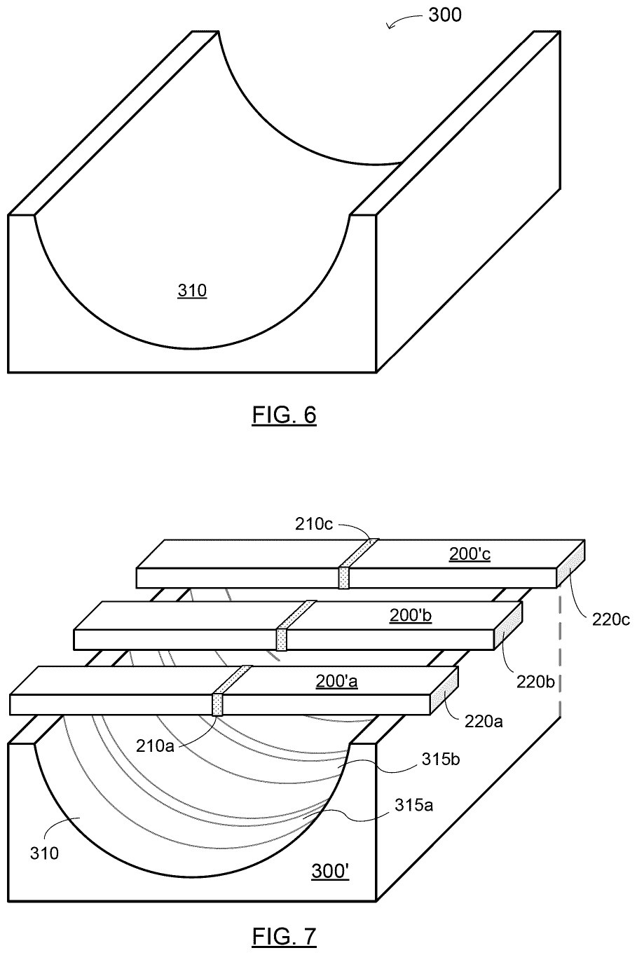

FIG. 6 shows an exemplary base 300 of an apparatus for shaping the cell pair stacks 200′ into curved forms. The example shown in FIG. 6 has a curved inner surface 310, in the shape of a partial (e.g., truncated or segmented) cylinder, similar to a half-pipe. Other shapes are also contemplated, such as a partial oval, part-curved and part-linear, etc. The lowermost surface of the base 300 is typically wider than the opening in the uppermost surface exposing the curved surface 310. The base 300 may comprise a thermally conductive material, such as a metal (e.g., aluminum, titanium, alloys thereof, etc.), which may be coated with a thin, relatively non-adhesive ceramic or polymer film (e.g., a silica glass, polytetrafluoroethylene, etc.). The base may also have one or more grooves or slots therein (e.g., 315a-b in FIG. 7) configured to align the cell pair stacks 200′ in/on the base 300. The base 300 may contain any number of such grooves or slots, limited only by the size of the base and the width of the cell pair stacks 200′.

FIG. 7 shows a plurality of cell pair stacks 200′a-c aligned with or slots or grooves 315a-b in the inner surface 310 of the base 300′. Each of the cell pair stacks 200′a-c may have a length equal to or greater than the width of the opening or cavity in the base 300, but the invention is not limited to this arrangement. For example, the cell pair stacks 200′a-c may have a length less than the width of the opening or cavity in the base 300, but the smaller the length of the cell pair stacks 200′a-c are relative to the width of opening or cavity in the base 300, the more recessed the ends 220a-c of the cell pair stacks 200′a-c will be in the cavity once pressed into the cavity. Ideally, the length of the cell pair stacks 200′a-c is from about 95% of the width of opening or cavity in the base 300 to the arc length of the inner surface 310 of the base 300, or when present, of the slot or groove 315. The slots or grooves 315a-b have a width equal to or slightly greater than the width of the cell pair stacks 200′a-c, optionally plus two times the thickness of the band(s) 210a-c. In the example shown in FIG. 7, the slot or groove 315 with which cell pair stack 200′c is aligned is not identified. The base 300′ extends beyond the dashed line at the back of the drawing, to accommodate additional cell pair stacks.

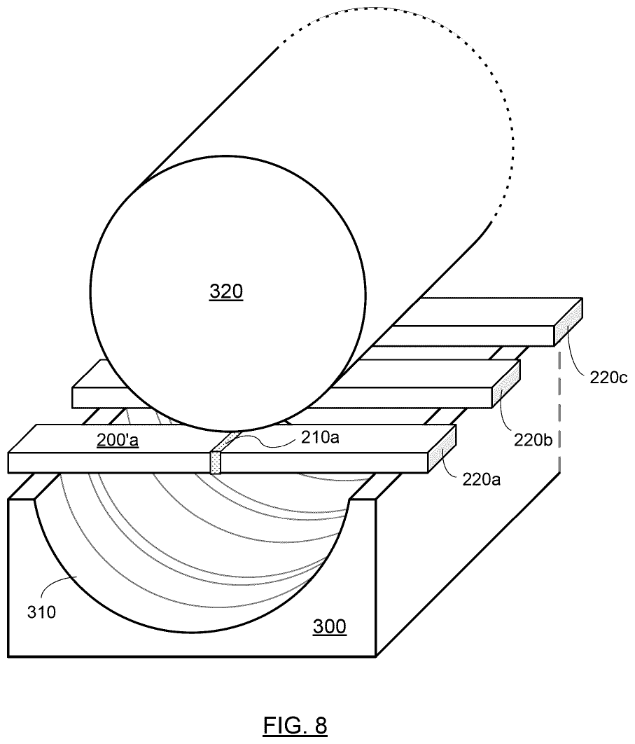

As shown in FIG. 8, a shaping tool such as a rod or cylinder 320 is lowered across the cell pair stacks 200′a-c into the cavity in the base 300, forcing the stacks 200′a-c to bend along the curved inner surface 310 of the base 300 and enter the corresponding slots or grooves 315, when present. The shaping rod or cylinder 320 may have another shape, such as a semi-cylinder, as long as it has an outer surface complementary or substantially complementary to that of the base 300. When the base 300 has a shape other than a truncated or segmented cylinder, the shaping rod 320 generally has a shape or an outer surface complementary or substantially complementary to the inner surface of the base 300. When the cell pair stacks 200′a-c have a length greater than the width of the opening or cavity in the base 300, the base 300 may have corresponding alignment notches in its uppermost surface, aligned with and having a same width as the slots or grooves 315.

The rod or cylinder 320 may comprise an incompressible or substantially incompressible material (e.g., a metal, a ceramic such as a silica or silicate glass, etc.) and have a length equal or substantially equal to the length of the base 300 or the inner surface 310. The dashed line at the back of the rod or cylinder 320 indicates that the rod or cylinder 320 extends beyond the dashed line. The rod or cylinder 320 may be fixed to a motor (not shown) that controls the vertical movement of the rod or cylinder 320. The rod or cylinder 320 may also be replaced with a partial rod or cylinder, truncated horizontally along its length so that its lowermost surface complements the inner surface 310 of the base 300 and its uppermost (horizontal) surface is at or above the uppermost surfaces of the base 300 when the partial rod or cylinder is fully inserted into the cavity in the base 300. The partial rod or cylinder weighs less than a complete partial rod or cylinder 320, and thus requires less energy to raise and lower. Additionally, when the rod or cylinder 320 is truncated, the curved surface of the rod or cylinder 320 may have an arc length about equal to or slightly greater than the length of the stacks 200′a-c, which may facilitate subsequent processing.

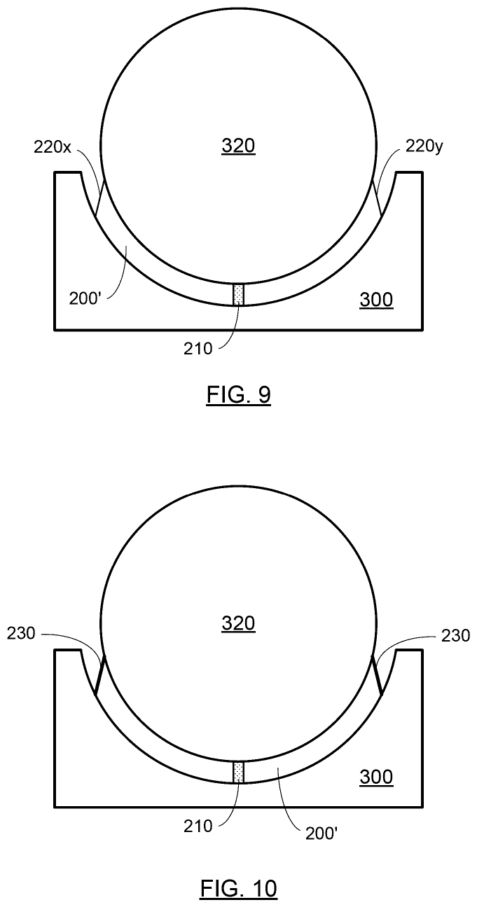

As shown in FIG. 9, after compressing the cell pair stacks 200′, the ends 220x-y of the stacks 200′ are exposed in gaps between the rod or cylinder 320 and the inner surface 310 of the base 300. One of the ends 220x-y of the stacks 200′ contains the exposed CCC contact surfaces (e.g., 115 in FIGS. 1-4), and the other contains the exposed ACC contact surfaces (e.g., 165 in FIGS. 1-4). Referring now to FIG. 10, the ends 220x-y of the stacks 200′ with the exposed CCC and ACC contact surfaces are then coated with a flexible conductive adhesive 230. For example, ends 220x-y containing the exposed CCC and ACC contact surfaces 115 and 165 (FIGS. 1-4) are coated with a flexible conductive epoxy 230 to electrically gang the terminals and form the CCC and ACC terminals of the packaged battery. The conductive adhesive 230 may comprise an Ag-filled or Ni-filled conductive epoxy paste, or another conventional conductive adhesive. Alternatively, a pin-to-pin paste transfer method may be used to apply the conductive adhesive 230 to the ends 220x-y of the curved cell pair stacks 200′.

The conductive adhesive 230 may be cured at a temperature of 80-200° C., or any temperature or range of temperatures therein (e.g., 120-175° C.), but the invention is not limited to this range. Thus, in some embodiments, the base 300 may be thermally conductive or include a thermally conductive material on its inner surface 310, and further include a heating element (not shown) configured to heat the ends 220x-y of the curved cell pair stacks 200′ (and thus, the conductive adhesive 230 and the curved cell pair stacks 200′ themselves) to a temperature sufficient to cure the conductive adhesive 230. Heating the curved cell pair stacks 200′ may facilitate the curved cell pair stacks 200′ retaining their shape after the shaping process (e.g., using the base 300 and the rod or cylinder 320).

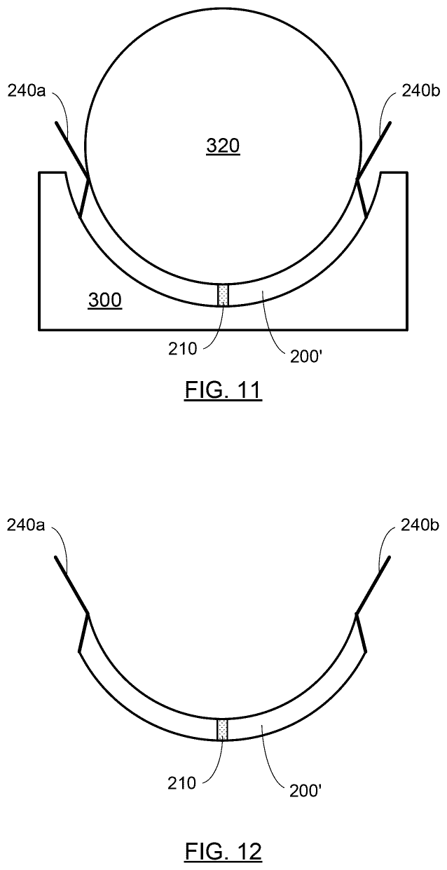

Battery terminals (e.g., electrically conductive tabs) 240a-b are then placed on the conductive adhesive 230 at each end 220x and 220y of the curved cell pair stacks 200′ in the shaping apparatus 300/320, as shown in FIG. 11. The terminals 240a-b may then be placed in electrical contact with or otherwise electrically connected to one or more electrical circuits. For example, the terminals 240a-b may be attached to traces on a printed circuit board (PCB) by soldering. For soldering, the tabs may have a surface comprising Ni, In and/or Sn (e.g., a bilayer comprising In or Sn on Ni). After the terminals 240a-b are secured to the ends 220x and 220y of the curved cell pair stacks 200′, the rod or cylinder 320 is raised, and the tabbed, curved stacks 200′ are removed from the base 300.

Once cured, the stacks 200′ maintain their shape (e.g., radius) and can be packaged, as shown in FIG. 12. For example, the tabbed curved battery stacks 200′ can be placed in a polymer sleeve or wrapped with a polymer film, and sealed (e.g., under vacuum). The polymer may be a polyester (e.g., a biaxially-oriented polyethylene terephthalate [PET] film), polyamide, polyethylene (PE), polypropylene (PP), polyvinyl chloride (PVC) or another polyolefin. Once sealed in the polymer film/sleeve, the battery is packaged and ready for use. In further embodiments, the polymer film is coated or laminated with a thin metal film (e.g., aluminum) for labelling prior to packaging. In one example, the sleeve or film comprises a polymer-aluminum laminate film, including a polyamide (e.g., a polycaprolactam that may comply with Japanese Industrial Standard JIS Z1714 for biaxially oriented polyamide films), aluminum foil (which may comply with Japanese Industrial Standard JIS A8079 and/or A8021), and an adhesive (e.g., a polyester-polyurethane adhesive) therebetween. The polyamide may have a thickness of 0.025 mm ±0.0025 mm, the aluminum foil may have a thickness of 0.040 mm ±0.004 mm, and the adhesive may be applied in a mass per unit area of 4-5 g/m². The laminate may further include an outer layer of polypropylene, adhered to the aluminum foil with a urethane-free adhesive applied in a mass per unit area of 2-3 g/m². Such sleeves and films can be obtained from Xiamen TOB New Energy Technology Co., Ltd., Xiamen, China, and other sources.

The present curved solid-state battery and method are unique, and may have an additional advantage to those described above. The flexibility inherent in a thin metal foil substrate (which may be thinned during processing of the cells) in the battery cells allow it to be used as a base unit or a common unit for many sizes and shapes of curved solid-state batteries. This greatly limits the number of stock keeping units (SKUs) necessary to produce a relatively large number of different batteries.

### Conclusion

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated.

1. A curved solid-state battery, comprising:
a plurality of curved, stacked solid-state battery cells, wherein each of the solid-state battery cells comprises a cathode current collector (CCC), a cathode on the CCC, a solid-state electrolyte on the cathode, and an anode current collector (ACC) on the solid-state electrolyte, and
first and second terminals on opposite sides or ends of the curved solid-state battery.

2. The curved solid-state battery of claim 1, further comprising a barrier and/or insulation film on the ACC with a via or opening therein exposing the ACC, and a conductive redistribution layer on the barrier and/or insulation film, in electrical communication with the ACC through the via or opening.

3. The curved solid-state battery of claim 2, wherein each of the solid-state battery cells has a first sidewall, the barrier and/or insulation film has a portion on the first sidewall, and the redistribution layer is on the portion of the barrier and/or insulation film.

4. The curved solid-state battery of claim 1, further comprising a flexible conductive adhesive on each of the first and second terminals.

5. The curved solid-state battery of claim 4, further comprising a first electrically conductive tab or trace affixed or secured to one of the first and second terminals, and a second electrically conductive tab or trace affixed or secured to the other of the first and second terminals.

6. The curved solid-state battery of claim 1, wherein the plurality of curved, stacked solid-state battery cells may have a shape of an arc, a parabola, a piriform curve, a partial ellipse, a bell curve, a cycloid, or a combination thereof.

7. The curved solid-state battery of claim 5, wherein the shape of the plurality of curved, stacked solid-state battery cells further includes one or more linear or substantially linear sections.

8. The curved solid-state battery of claim 1, wherein the stacked solid-state battery cells comprise a plurality of face-to-face pairs of the solid-state battery cells with an adhesive between adjacent faces of each pair of the solid-state battery cells, wherein adjacent pairs of the solid-state battery cells directly contact each other.

9. The curved solid-state battery of claim 1, wherein the stacked solid-state battery cells comprise a plurality of face-to-back pairs of the solid-state battery cells with an adhesive between adjacent cells of each pair of the solid-state battery cells, and either a compressible layer or an additional adhesive layer between adjacent pairs of the solid-state battery cells.

10. The curved solid-state battery of claim 1, wherein the CCC comprises an aluminum, copper, titanium, nickel, iron, or stainless steel foil having an exposed surface providing a contact on a CCC side or edge of the solid-state battery cell.

11. The curved solid-state battery of claim 1, further comprising one or more straps or bands around the plurality of curved, stacked solid-state battery cells.

12. The curved solid-state battery of claim 1, further comprising a protective encapsulant around the plurality of curved, stacked solid-state battery cells.

13. A method of making a curved solid-state battery, comprising:
making a plurality of solid-state battery cells on a conductive metal or metal alloy substrate, each of the solid-state battery cells having an insulating coating on a first major surface and a conductor on a second, opposite major surface, wherein the conductor is configured to form a first contact at a first edge of the solid-state battery cell, and the conductive substrate has an exposed surface providing a second contact on a second edge of the solid-state battery cell, the second edge being opposite from the first edge,
stacking pairs of the plurality of solid-state battery cells using an adhesive to create a plurality of cell pairs,
stacking at least some of the plurality of cell pairs,
compressing the stacked cell pairs in a shaping device to form curved stacked cell pairs, and
terminating the first and second edges of the curved stacked cell pairs with a conductive adhesive.

14. The method of claim 13, further comprising strapping or banding the stacked cell pairs together prior to compressing the stacked cell pairs.

15. The method of claim 13, further comprising fixing or securing an electrically conductive tab to each of the terminated first and second edges of the curved stacked cell pairs.

16. The method of claim 13, wherein the substrate comprises an aluminum, copper, titanium, nickel, iron, or stainless steel foil.

17. The method of claim 13, wherein:
the pairs of the plurality of solid-state battery cells are stacked face-to-face, the adhesive comprises an anisotropic conductive film (ACF), and the plurality of cell pairs are stacked without additional adhesive between adjacent ones of the plurality of cell pairs; or
the pairs of the plurality of solid-state battery cells are stacked face-to-back using the adhesive, and the plurality of cell pairs are stacked with either a compressible layer or an additional adhesive between adjacent ones of the plurality of cell pairs.

18. The method of claim 13, further comprising individually encapsulating the curved stacked cell pairs in a flexible, protective packaging.

19. A shaping device, comprising:
a base having an opening or cavity exposing a curved inner surface, the curved inner surface having a plurality of parallel grooves or slots therein, each of the grooves or slots being configured to accommodate a stack of solid-state battery cells therein, and
a shaping tool configured to impart a curved shape to the stack of solid-state battery cells in each of the grooves or slots, comprising an incompressible or substantially incompressible material, and having (i) a length substantially equal to a length of the inner surface of the base and (ii) a curved outer surface complementary or substantially complementary to the inner surface of the base.

20. The shaping device of claim 19, wherein:
each of the grooves or slots has a width at least equal to and not more than 20% greater than a width of the stack of solid-state battery cells and an arc length greater than a length of the stack of solid-state battery cells,
the opening or cavity in the base has a width equal to or less than the length of the stack of solid-state battery cells,
the base is thermally conductive or includes a thermally conductive material on the inner surface, and
the base further includes a heating element configured to heat (i) ends of the stacks of solid-state battery cells to a temperature sufficient to cure a conductive adhesive thereon and/or (ii) the stacks of solid-state battery cells to a temperature facilitating the stacks of solid-state battery cells retaining the curved shape after removal from the shaping device.
